(19) United States
(12) Patent Application Publication
(10) Pub. No.: US 2003/0072896 A1
(43) Pub. Date: Apr. 17, 2003

(54) Photo-induced alignment materials and method for LCD fabrication

(75) Inventors: Hoi-Sing Kwok, Kowloon (CN); Wing-Chiu Yip, Kowloon (CN); Vladimir Chigrinov, Kowloon (CN); Vladimir Kozenkov, Kowloon (CN); Elena Prudnikova, Kowloon (CN)

Correspondence Address: HESLIN ROTHENBERG FARLEY & MESITI PC, 5 COLUMBIA CIRCLE, ALBANY, NY, 12203, US

(73) Assignee: The Hong Kong University of Science and Technology, Kowloon (CN)

(21) Appl. No.: 10/165,050

(22) Filed: Jun. 7, 2002

Related U.S. Application Data
(60) Provisional application No. 60/296,641, filed on Jun. 7, 2001.

(51) Int. Cl. C09K 19/00

(52) U.S. Cl. 428/1.23; 428/1.2

(57) ABSTRACT

The present invention relates to chemical compositions of synthetic dyes and a fabrication process for the photo-induced alignment of liquid crystals. The compositions and methods of the invention are applicable to lateral field driven LCDs such as the In-plane Switching mode. A method of alignment using a multiple wavelengths light source is disclosed. This is a non-contact technique to align liquid crystals so that the particulates and static charges generated by the rubbing process can be eliminated. A synthetic dye film is exposed to a linearly polarized or non-polarized light. Due to photoisomerization, conformational molecular change occurs, and the isomer orientation is no longer random but becomes anisotropic. This in turn gives rise to a homogeneous anisotropic orientation of the liquid crystal molecules. This liquid crystal orientation is in general not parallel to the isomer major molecular axis, and yet the relation can be deduced from the polarization vector and incidence angle of the illumination. The oblique incidence of the light exposure will favour a non-zero pretilt angle. The order parameter as a measure of this alignment effect is large for most of the synthetic dyes disclosed in this invention. The azimuthal anchoring energy associated with the synthetic dye can be many-fold lower than its polyimide counterpart, and therefore a sizeable reduction in the LCD drive-voltage is possible.

### RELATED APPLICATIONS

This application claims the benefit of U.S. Provisional Application No. 60/296,641 filed on Jun. 7, 2001, the teachings of which are incorporated herein by reference in their entirety.

### BACKGROUND OF THE INVENTION

1. Field of the Invention

In this invention, the chemical compositions of synthetic dyes and a fabrication method for photo-alignment technology are disclosed.

2. Related Art

The alignment layers for liquid crystal displays (LCDs) and other liquid crystal (LC) devices are usually based on a polyimide film of 10-50 nm thickness. The alignment of liquid crystals is induced by mechanical rubbing or brushing. However, tiny particles and static charges are generated in this process and these have been reported as one of the major causes in defective displays. There is also a problem of cross contamination which is very difficult to minimize. For active-matrix liquid crystal displays (AMLCDs), these problems are unresolved.

In contrast, photo-alignment technology is a clean, non-contact process. Essentially, the photo-alignment layer is first exposed to polarized or non-polarized light and a conformational molecular change is caused by photoisomerization. The order parameter can then be assessed as a measure of this conformation alignment.

Currently, there are several groups of materials suitable for this purpose, such as polyimide, polyvinylcinnamate and polyester derivatives. Usually, high exposure energy is required for polyimide derivatives and free radicals are generated by photo-dissociation as by-products. The impact due to these free radicals on the LCD life time is not yet well understood. For the other two polymeric derivatives, thermal stability and compatibility with the LCD manufacturing process are primary issues which have to be solved.

The other alternative is a synthetic dye, which can be made very sensitive, water-soluble, metal-free, thermal and UV stable. This is one of the most comprehensively studied materials in history and reports on the homogeneous photo-alignment of liquid crystals can be dated back to the early 80's. Nowadays, there are large synthetic dye producers all over the world who can manufacture these synthetic dyes on an industrial scale. The quality and quantity of such dyes are guaranteed and stable. Nevertheless, since a liquid crystal is a weak electrolyte, synthetic dyes of low molecular weight may be dissolved very slowly. This is a long term issue to scrutinize although the dissolution rate is extremely slow and is virtually unnoticeable for those synthetic dyes used in the photo-induced alignment of a liquid crystal. Any inter-molecular hydrogen bond introduced in the dye molecules may help to minimize this problem. Synthetic dyes can also be cross-linked in a polymeric main chain. This however reduces the order parameter drastically and may cause disclination lines in the liquid crystal medium.

U.S. Pat. No. 5,032,009 suggests a method for the alignment of a liquid crystal by exposing anisotropic absorbing molecules (1) dispersed on the substrate or (2) in the liquid crystal medium to a linearly polarized light. This may result in an ordering of the liquid crystal molecules along or perpendicular to the direction of the polarization vector. Different examples of aligning liquid crystals using dichroic dyes, polyimide and their combinations were also described. However, the dichroic dyes in use were soluble in the liquid crystal medium, which limited the choice to align the medium effectively. In addition, there were many open questions not yet answered, and the materials reported were basically designed for guest-host LCDs, which were considered unreliable and inefficient for LCD photo-alignment technologies. One of the disadvantages of these materials was the difficulty in controlling the azimuthal anchoring energy on the substrate. How could this problem be solved for the thermal stability had never been addressed.

### SUMMARY OF THE INVENTION

In the present invention, we propose new dyes, especially fluorinated dyes, and a fabrication process for the photo-induced alignment of liquid crystals. It has been discovered that sulphonated groups can help stabilize the dye molecules on different substrates, even at an elevated temperature, whereas fluorinated substitutes for the carbonyl groups can minimize the ionic dissociation and hence improve the voltage holding ratio. In addition, these molecules are photochemically and thermally stable. They also exhibit promising characteristics for the fluorinated liquid crystals commonly used in AMLCDs. Display cells of different modes such as TN and IPS have been fabricated in accordance with this invention, and good results have also been measured. The order parameter has been found to be very large in the materials of the present invention. Thus, a very good homogeneous anisotropic orientation of the liquid crystal and a non-zero pretilt angle can be induced. This process is compatible with the clean-room requirement and the fabrication of the AMLCDs.

The present invention relates to chemical compositions of synthetic dyes and a fabrication process for a photo-alignment layer. One embodiment of the invention is a method using a multiple wavelengths light source to improve the efficiency of the alignment process. This is a non-contact technique to align liquid crystals so that the particulates and static charges generated by the rubbing process can be eliminated. To prepare the photo-alignment layer, the synthetic dye film is exposed to a linearly polarized or non-polarized light. Due to photoisomerization, a conformational molecular change occurs and the isomers transform to a preferential position. Thus, the isomer orientation is no longer random but becomes anisotropic. This in turn gives rise to a homogeneous anisotropic orientation of the liquid crystal molecules as a result of the dispersion forces at the alignment layer-liquid crystal interface. This liquid crystal orientation is in general not parallel to the isomer major molecular axis, and yet the relation can be deduced from the polarization vector and incidence angle of the illumination. In fact, the oblique incidence of the light exposure will favour a non-zero pretilt angle. The order parameter as a measure of this alignment effect is large for most of the synthetic dyes disclosed in this invention, and very good contrast has been measured in the TN-LCD using these materials. In addition, since the azimuthal anchoring energy associated with the synthetic dye can be many-fold lower than its polyimide counterpart, a sizeable reduction in LCD drive-voltage is possible. In other words, it is advantageous to apply this technology for the lateral field driven LCDs such as the In-plane Switching mode.

The invention inter alia also includes the following embodiments, alone or in combination.

One embodiment of the present invention is a compound of the general formula

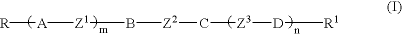

or a salt thereof, in which m and n each independently represent 1 or 2, preferably 1; A, B, C and D each independently represent an optionally substituted arylene, especially phenylene or naphthylene, cycloalkylene, especially cyclohexylene, or heteroarylene group;

Z¹, Z² and Z³ each independently represent —N═N—, —CH═CH—, —NH—, —S—, —SO₂, —CH₂—, —CH═N—, —N═CH—, —HN—CO—NH—, —OCH₂—, —CH₂O—, —C—C—, —O—, —O—CO—, —CO—O— or a single bond, and Z² additionally represents a squarylium or pyridine group; and R and R¹ each independently represent a group

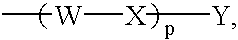

where p is 0, 1 or 2, the or each W represents —O—, —S—, —SO₂—, —CH₂—, —N═ or a single bond, the or each X represents a linear spacer group containing 1 to 8, preferably 1 to 6, carbon atoms, and Y represents a hydrogen atom or a hydroxyl, carboxyl, nitro, haloalkyl, cyanoalkyl, hydroxyalkyl, alkoxy, haloalkoxy, amino, dialkylamino, or di(hydroxyalkyl) amino group.

According to an embodiment of the invention, any alkyl group, unless otherwise specified, is linear or branched and may contain up to 12, preferably up to 8, more preferably up to 6, and especially up to 4, carbon atoms. Preferred alkyl groups are n-alkyl groups, that is, linear alkyl groups, with methyl, ethyl, propyl and butyl groups being especially preferred.

According to an embodiment of the invention, a cycloalkylene group is any saturated cyclic hydrocarbon group and may contain from 3 to 12, preferably 5 to 8 carbon atoms. Preferred cycloalkylene groups include cyclohexylene groups. An arylene group may be any monocyclic or polycyclic aromatic hydrocarbon group and may contain from 6 to 14, especially 6 to 10, carbon atoms. Preferred arylene groups include phenylene, naphthylene, anthrylene and phenanthrylene groups, especially a phenylene or naphthylene, and particularly a phenylene, group. A heteroarylene group may be any aromatic monocyclic or polycyclic ring system which contains at least one heteroatom. Preferably, a heteroarylene group is a 5- to 10-membered, and especially a 6- to 10-membered, aromatic ring system containing at least one heteroatom selected from oxygen, sulphur and nitrogen atoms. Most preferably, a heteroarylene group is a phenylene or naphthylene group in which at least one of the carbon atoms has been replaced by a nitrogen atom.

A halogen atom may be a fluorine, chlorine, bromine or iodine atom. Fluorine atoms are particularly preferred.

When any of the foregoing substituents are designated as being optionally substituted, the substituent groups which are optionally present may be any one or more of those customarily employed in the development of anisotropically absorbing materials and/or the modification of such compounds to influence their structure/activity, stability or other property. Specific examples of such substituents include, for example, halogen atoms, nitro, cyano, hydroxyl, alkyl, haloalkyl, alkoxy, haloalkoxy, amino, alkylamino, dialkylamino, formyl, alkoxycarbonyl, carboxyl, alkanoyl, haloalkanoyl, alkylthio, alkylsulphinyl, alkylsulphonyl, —SO₃H, —SO₃Na, carbamoyl and alkylamido groups. When any of the foregoing substituents represents or contains an alkyl substituent group, this may be linear or branched and may contain up to 12, preferably up to 6, and especially up to 4, carbon atoms. A halogen atom may be a fluorine, chlorine, bromine or iodine atom and any group which contains a halo moiety, such as a haloalkyl group, may thus contain any one or more of these halogen atoms.

Preferably, m and n both represent 1.

It is preferred that A, B, C and D are each optionally substituted by 1 to 4 substituents selected from the group consisting of halogen atoms, hydroxyl, carboxyl, nitro, cyano, amino, —SO₃H, —SO₃Na, C₁₋₆ alkyl, C₁₋₆ haloalkyl, C₁₋₆ alkoxy, C₁₋₆ haloalkoxy, C₁₋₆ alkanoyl and C₁₋₆ haloalkanoyl groups. More preferably A, B, C and D are each optionally substituted by 1 or 2 substituents selected from the group consisting of halogen atoms, hydroxyl, carboxyl, nitro, cyano, amino, —SO₃H, —SO₃Na, methyl and trifluoromethyl groups.

Preferably, each group A, B, C and D is joined through the 1- and 4-positions of the ring system. Thus, it is preferred that A, B, C and D each independently represent a 1,4-arylene, especially 1,4-phenylene or 1,4-naphthylene, a 1,4-cycloalkylene, especially 1,4-cyclohexylene, or 1,4-heteroarylene group. More preferably, A, B, C and D each represent a 1,4-phenylene group.

Preferably, A and D are the same and B and C are the same or A and C are the same and B and D are the same. However, compounds in which A and D are the same and B and C are the same are most preferred.

Preferably, Z¹ and Z³ represent —N═N— and Z² represents a single bond.

Although p can be 0 or 1, it is preferred that p is 0. Preferably, Y represents a hydrogen atom or a hydroxyl, carboxyl, C₁₋₈ alkyl, especially trifluoromethyl, or C₁₋₈ alkoxy group.

Compounds in which m and n are both 1, A and D both represent a 1,4-phenylene group optionally substituted at the 3- and 5-positions by a carboxyl group or a trifluoromethyl group; B and C both represent a 1,4-phenylene group substituted by a —SO₃Na group; and R and R¹ both represent a hydroxy group or a C₁₋₈ alkoxy group are especially preferred.

Suitable salts include acid addition salts and these may be formed by reaction of compound of formula (I) with a suitable acid, such as an organic acid or a mineral acid. Suitable salts also include metal salts of compounds in which a substituent bears a terminal carboxyl group. Such metal salts are preferably formed with an alkali metal atom, such as a lithium, sodium or potassium atom, or with a group —AHal, where A is an alkaline earth metal atom, such as magnesium, and Hal is a halogen atom, preferably a chlorine, bromine or iodine atom. Sodium salts are particularly preferred.

Another embodiment of the invention is a compound of the general formula I, as described previously, or a synthetic dye selected from the group consisting of vat, indigoid, phthalocyanine, aryl carbonium, polymethine, sulphur, nitro squarylium, nitroso squarylium and fluorescent dyes, and an additive to promote adhesion and pretilt angle to a substrate. Preferably the additive is selected from the group consisting of silane derivatives, titanate derivatives and fluorocarbon surfactants.

An embodiment of the method of the invention is a process for preparing a photo-alignment layer on a substrate comprising the steps of

(a) selecting and cleaning the substrate;

(b) depositing a film of the composition described above onto the substrate;

(c) optionally baking the film to remove any solvent;

(d) illuminating the film with actinic radiation directed through at least one aperture mask in a pre-determined region of the film to form a single-domain structure; and

(e) optionally repeating step (d) with a plurality of aperture masks to form a multi-domain structure.

Preferably the substrate is a glass, silicon or plastic substrate.

Yet another embodiment of the invention is a liquid crystal device incorporating a photo-alignment layer produced by the process described above.

### BRIEF DESCRIPTION OF THE DRAWINGS

FIG. 1 Chemical formulae of fluorinated and sulphonated dye molecules for the preparation of a photo-alignment layer.

FIG. 2 The absorption spectra of SD-1 and SD-2.

FIG. 3 The linear dependence of the absorption-induced orientation of SD-1.

FIG. 4 The optical anisotropy of SD-1 against time as a function of average illumination intensity.

FIG. 5a-b A high level process flow to prepare a pixelated photo-alignment layer in accordance with the invention.

FIG. 6 Schematic illustration of oblique exposure of a photo-alignment layer with non-polarized light.

FIG. 7 Schematic illustration of the multi-domain structures created by the oblique exposure of a photo-alignment layer with (a) linearly polarized light and (b) non-polarized light.

FIG. 8 Transmission voltage curves of TN-LCD using SD-1 and polyimide PIA3744 as the alignment layer.

### DETAILED DESCRIPTION OF THE PREFERRED EMBODIMENTS

The present invention provides materials and a fabrication process to prepare a photo-alignment layer for the LCDs production.

A preferred subset of compounds falling within the scope of formula (I) are compounds according to formulae (II) and (III) where a homogeneous orientation of the liquid crystals can be induced by exposure to an actinic radiation:

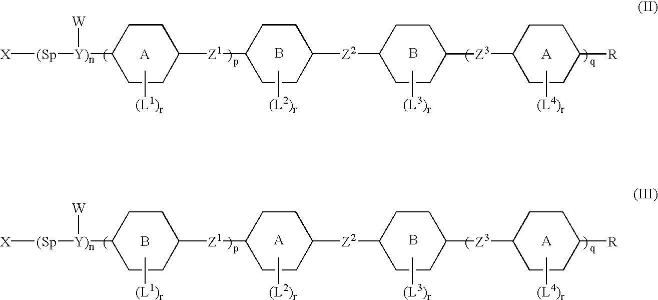

in which

W, X and Y are each independently —O—, —S—, —SO₂—, —CH₂—, —N═, —CF₃, —COOH, —OH, —H, —NO₂, —NH₂, —CₙH₂ₙCN, —CₙH₂ₙOH, —N(CₙH₂ₙ₊₁)₂, —N(CₙH₂OH)₂ or a single bond

where n is from 1 to 8;

Sp is a linear spacer group with 1 to 8 carbon atoms;

A and B each independently denote 1,4-phenylene, 1,4-cyclohexylene or 1,4-naphthalene, with one or more of the C atoms of the 1,4-phenylene or 1,4-naphthalene molecule being optionally replaced by N atoms;

Z¹ and Z³ are each independently —N═N—, —CH═CH—, —NH—, —S—, —SO₂—, —CH₂—, —CH═N—, —HNCONH—, —OCH₂—, —CH₂O—, —C≡C—, —O—, —OCO—, —COO— or a single bond, and Z² is selected from a squarylium group or pyridine group, or represents —N═N—, —CH═CH—, —NH—, —S—, —SO₂—, —CH₂—, —CH═N—, —HNCONH—, —OCH₂—, —CH₂O—, —C≡C—, —O—, —OCO—, —COO— or a single bond;

R is represented by the general formula (IV):

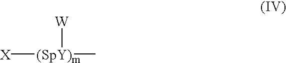

where m is 0 or 1 in formula (IV), and W, X, Y and Sp are as defined above;

n is 0, 1 or 2;

p and q are each independently 1 or 2;

L¹, L², L³ and L⁴ are each independently —CF₃, —COOH, —CH₃, —SO₃H, —NO₂, —NH₂, —CN, —OH, —H or halogen atoms; or denote alkyl, alkoxy or alkanoyl each having up to 6 carbon atoms and with one or more H atoms being optionally substituted by F or Cl; and

r is 0, 1 or 2.

The spacer group, as stated above, is a linear spacer group with 1 to 8 carbon atoms. Preferably the spacer group has 1 to 6 carbon atoms, more preferably it is a simple alkylene chain having from 1 to 8 (most preferably 1 to 6) carbon atoms.

The compounds of the invention can be used in place of a rubbed polyimide film, by preparing a synthetic dyes admixture for the photo-alignment layer comprising:

a) synthetic dyes comprising compounds of formulae I, II and III described above, and

b) additives to promote the adhesion and pretilt angle to different substrates.

The resulting photo-alignment layer can be used for the twist and non-twist LCD configurations with planar or hybrid boundary conditions.

The synthetic dyes can also be chosen from vat, indigoid, phthalocyanine, aryl carbonium, polymethine, sulphur, nitro (and nitroso) squarylium or fluorescence dyes.

The synthetic dyes disclosed in the invention are anisotropic organic compounds and are based on photochemically stable materials.

The additives can be silane and titanate derivatives or fluorocarbon surfactants.

Examples are dimethyl diethoxysilane and polydimethylsiloxane.

A preferred fabrication process for producing a pixelated photo-alignment layer according to the invention comprises the following steps:

a) Cleaning a substrate using hot alkaline detergents or acids before rinsing in deionized water. Preferably ultrasonic agitation is used to reduce the substrate cleaning time.

b) Depositing a film of the synthetic dyes admixture described above on top of the substrate. The coated side will be in contact with the bulk liquid crystals.

c) Baking the synthetic dye film, if a solvent is used. The preferred temperature and duration are 80-105° C. and 1-10 min respectively.

d) Illuminating the synthetic dye film with actinic radiation in the pixelated regions where the exposure to the radiation is intended for a single-domain structure.

e) Optionally repeating step (d) with separate set of masks and polarization vectors to form multi-domain structures.

In the process of the invention (for example, see step (b) above) the synthetic dyes film of the invention may be deposited or cast by:

i) vacuum evaporation,

ii) silk-screen or offset printing, or

iii) spin and dip coating.

When deposited, the thickness of the photo-alignment layer can be less than 10nm, and increases in proportion to minimize the coverage problem on a rough substrate surface, especially those with integrated circuitry.

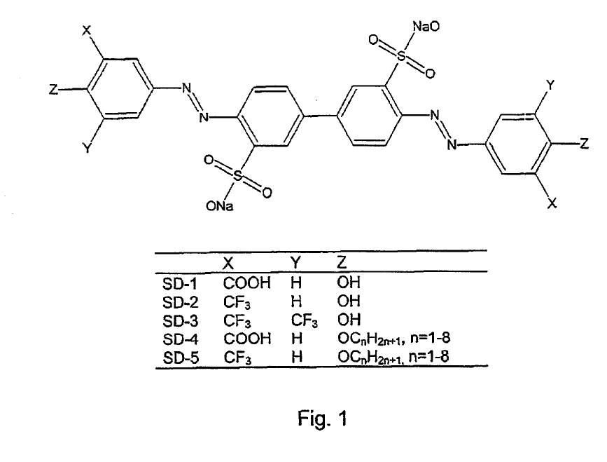

When actinic radiation is used in this preferred process (see step (d) above), it can be a multi-wavelengths light source. This has been found to be more efficient to promote the photo-induced alignment of liquid crystals. An exposure energy of 5 J/cm² is sufficient for the stable alignment purpose, and this is typical for the example dyes shown in FIG. 1. In one embodiment of the method, the actinic radiation is directed through at least one aperture mask in a pre-determined region of the film to form a single-domain structure.

A preferred orientation of the liquid crystal can be induced by a linearly polarized or non-polarized radiation. A non-zero pretilt angle is favourable at an oblique incidence. The preferred orientation of the liquid crystal on a photo-alignment layer may be parallel or perpendicular to the polarization vector of the actinic radiation. For non-polarized actinic radiation, it may be parallel to the plane of oblique incidence. The preferred orientation depends on the molecular-molecular interactions between the liquid crystals and the photo-alignment materials. In the case of synthetic dyes SD-1 and SD-2, the induced molecular orientation of nematic liquid crystals is orthogonal to the polarization vector of the actinic radiation.

The photo-alignment layer herein described can be used in a liquid crystal display, for example by applying the synthetic dye to the internal substrate surface of an LCD. The liquid crystal display may consist of front and rear substrates which can be either flexible or rigid, and either transparent or opaque. When a transparent and flexible substrate is used, it can be polyethylene-terephthalate (PET), whereas when an opaque and rigid substrate is used it can be crystal silicon. The commercial Indium Tin Oxide glass can be used for high optical transparency. The substrate can be fabricated to contain transistors and integrated electrical circuitry. These are commonly found in AMLCDs.

The pixelated regions of these substrates can be different in size and their relative positions. For the optimal electro-optic performance, these regions match each other and form a quadruple or polygon structure. When such structures are formed, each quadrant or polygon so formed is referred to as a subpixel, whereas four or more of them constitute a pixel. A special case arises when all local axes are aligned in a particular direction: the pixels are then considered as a single large pixel covering the whole display area.

In preferred cases, the principal photo-induced orientation axis on each subpixel of the front substrate is aligned at an angle between −180 and 180 degrees with respect to that on the corresponding subpixel of the rear substrate. Preferably each subpixel or pixel has a size of a few microns.

Where a pixelated pattern of arbitrary shape is desired, this can be transferred to the photo-alignment layer using a projection or contact mask aligner. It is preferred that the orientation of the liquid crystal is the same in the exposed regions, whereas there is no preferred orientation in the unexposed regions. When a mask is used, it may consist of a plurality of regions with different light transmittance. There is preferably at least one transparent region and at least one opaque region in the mask. In one embodiment, the mask is an aperture mask, comprising a membrane having at least one aperture thereon. In preferred embodiments the mask is a photolithographic aperture or shadow mask.

When producing multi-domain structures the aperture mask can be manufactured using a thin photo-patterned light-polarization mask in order to manoeuvre a linearly polarized actinic radiation with a selected space distribution of the polarization vectors. Alternatively, the aperture mask can be manufactured using a photo-patterned thin birefringence mask (i.e. an electronically addressed liquid crystal cell sandwiched between the polarizer and analyzer) to manoeuvre a linearly polarized actinic radiation with a selected space distribution of the polarization vectors.

### DETAILED DESCRIPTION OF THE DRAWINGS

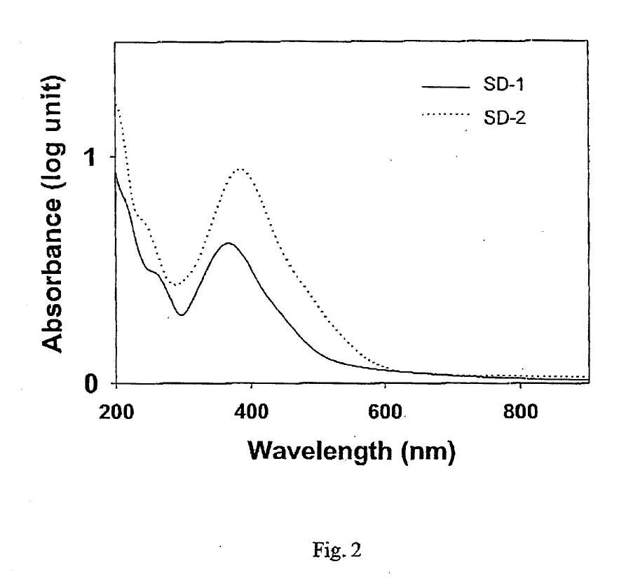

Referring now to the Drawings, in FIG. 1, dye molecules for the fabrication of a photo-alignment layer in accordance with this invention are shown. These are basically bisazo dyes and the absorption is due to the electronic transfer between the donor and the acceptor. The azobenzenes incorporated as the molecular skeleton are very effective for this purpose. The electronic drawing capability can be enhanced by the substitution of fluorine atoms, whereas hydrogensulfite —HSO₃, which is known to promote the water-solubility, can be substituted by other groups for high voltage holding ratio. The absorption spectra of SD-1 and SD-2 are shown in FIG. 2. The absorption peaks are 366.6 nm and 385.9 nm respectively. These chemicals fluoresce strongly when they are illuminated by a focused NeHe laser beam. So dynamic photoisomerization can be detected readily.

On the other hand, azobenzene derivatives such as those proposed in FIG. 1 have two geometric isomers: the trans and the cis forms. The isomerization reaction is a light- or heat-induced transformation between these two isomers. Two mechanisms may occur during the photoisomerization of the azobenzene derivatives: one from the high energy π-π* transition, which leads to the rotation around the nitrogen double bond; and the other from the low energy n-π* transition, which induces the isomerization by means of the inversion through one of the nitrogen nuclei. Both mechanisms will give rise to the same conformational molecular change, although the physical processes are different. The experimental results of the azobenzene derivatives favour the theory that the conformational molecular change induced by the polarized light is due to photoisomerization. When the azo dye molecules are optically pumped by a polarized light beam, the energy absorbed for the transformation is proportional to the square of the cosine 0, the angle between the transition dipole moments of the molecules and the direction of the polarized light. In other words, the azo dye molecules that have their transition dipole moments parallel to the direction of the polarized light will probably undergo the trans to cis isomerization. Since the cis isomer is not thermally stable and will relax to the trans form, a transformation to the conjugated position is energetically favourable. Thus, the anisotropic dichroism and optical retardation are photo-induced and the associated order parameter as a measure of this effect is found to be very large in some of these dyes.

Due to the molecular dispersion forces between the dyes and the liquid crystal molecules, a homogeneous anisotropic orientation of the bulk liquid crystal is induced. It has been discovered that certain organic photochemically stable substances, illuminated by a linearly polarized or non-polarized light, show a much higher degree of induced molecular order than those found in an active photochemical molecular layer.

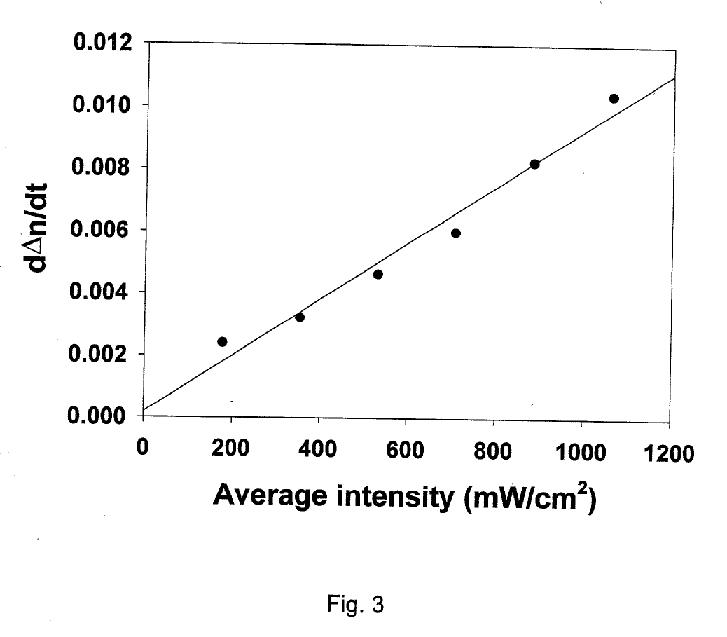

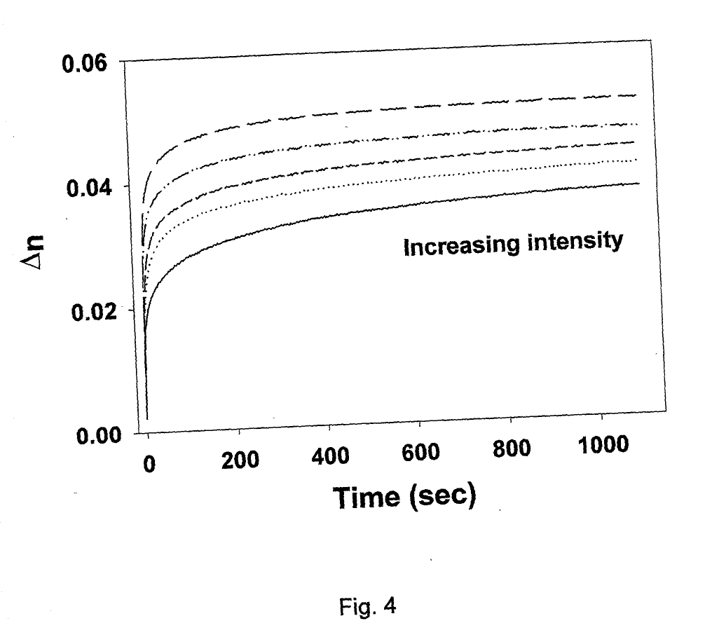

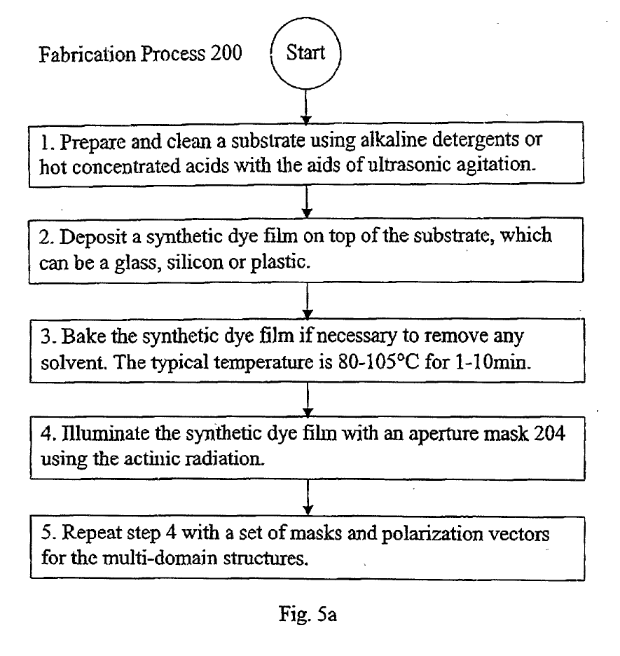

It has also been noticed that the molecular order, which is evaluated by photo-induced optical anisotropy, becomes saturated when the exposure energy reaches a critical value. Both the initial rate of change of optical anisotropy and its saturated value are roughly proportional to the average intensity of the light source. This linear dependence is a unique signature of absorption-induced reorientation, which is consistent with the published results. For SD-1, the experimental data and the linear regression, which are in good agreement, are plotted in FIG. 3. The wavelengths of the pump and probe laser beams are 488 nm and 633 nm respectively. The angle between the polarization vectors of these beams is 45°. In other words, the optical anisotropy as a function of illumination time can be measured and is shown in FIG. 4. It has been found that all the experimental data can be best fitted by a curve with two time constants. One is of the order of seconds and the other is of the order of hundreds of seconds. The former is attributed to isomerization near the surface and the latter is due to diffusion-limited transformation in the bulk. Both become shorter as the average intensity increases. Thus, the induced optical anisotropy and dichroism depend effectively on the average intensity, and the multi-wavelengths light source will help shorten the exposure time, provided that the emission peaks fall in the absorption spectrum of the dye molecule.

This is in contrast to the case where the molecular order is due to irreversible photochemical reaction. In this case, the induced optical anisotropy decreases for sufficiently high exposure energy and the molecular order depends on the exposure energy critically.

In addition, it is possible to induce the alignment of liquid crystals using obliquely incident non-polarized light. In this case, the molecular order in the photo-alignment layer increases with the exposure energy. The preferred orientation of the liquid crystal molecules is usually parallel to the plane of oblique incidence and the final orientation depends on the interaction between the liquid crystal and the dye molecules. Thus, expensive UV-polarizers can be eliminated and the whole production process of the photo-alignment layer can be considerably simplified. Dyes with the chemical formulae shown in FIG. 1 were used in the experiments. It was found that the fluorinated dyes have a lower refractive index, higher polarizability, higher packing density and higher surface tension compared with their non-fluorinated counterparts. They are more suitable for the fluorinated liquid crystals commonly used in AMLCDs, and they are photochemically and thermally stable for manufacturing displays.

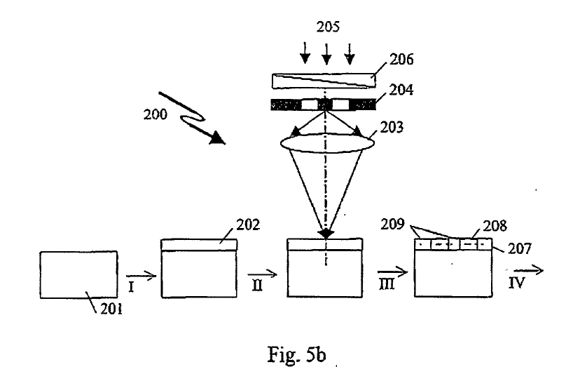

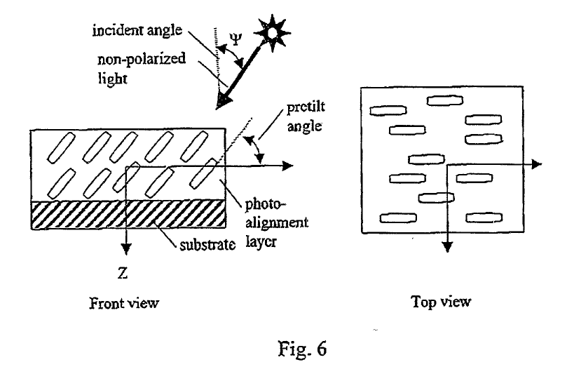

A fabrication flow chart 200 in accordance with the present invention is shown in FIG. 5a. In the first step of the process 200 (FIG. 5b), a photo-alignment layer 202 with a thickness of 1-20 nm is deposited on top of a glass, silicon or plastic substrate 201. An amorphous film of photochemical stable dyes (FIG. 1) was used as the photo-alignemnt layer 202. The layer was produced by spin coating, but silk-screen printing can be used. The layer 202 can also be deposited by dipping the substrate 201 in a solution of the dyes. After the formation of the solid film 202, it was illuminated by light source 205. The polarizer 206, aperture mask 204 and the lens 203 constitute a simple imaging system for the pattern transfer. In practice, a contact or projection mask aligner is used. The polarizer 206 can be eliminated, if the photo-alignment layer is exposed by the non-polarized light at an oblique incidence (FIG. 6 & 7).

After steps II and III have been completed (FIG. 5b), a local polarization axis 208 is formed in the illuminated regions of the dye film 207 (FIG. 5b), and the regions 209 where they are not illuminated show a random axis orientation. The operation III should be repeated to obtain a different local orientation axis distributed on the photo-alignment layer. A separate set of aperture masks and polarization vectors can be used for this purpose.

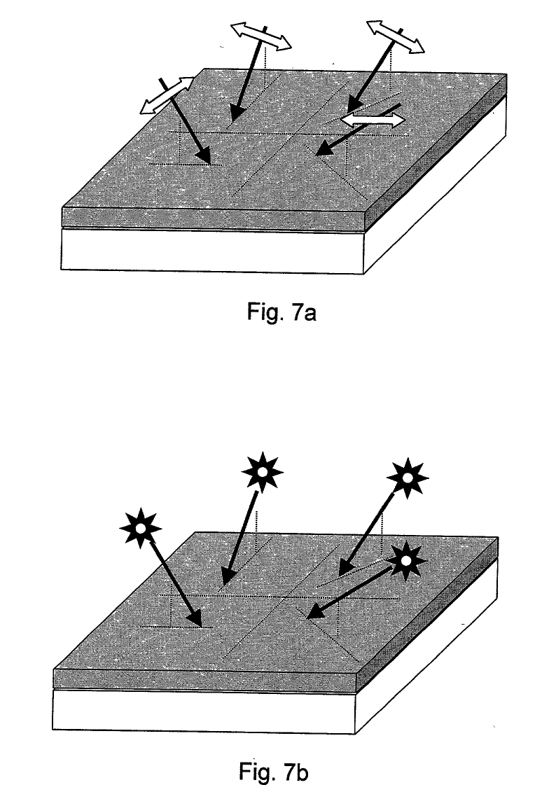

Thus, a fabrication process to manufacture a thin pixelated photo-alignment layer has been proposed. This process can also be used for the fabrication of multi-domain structures (FIG. 7). The feature size of each pixel element can be less than 10 μm. In

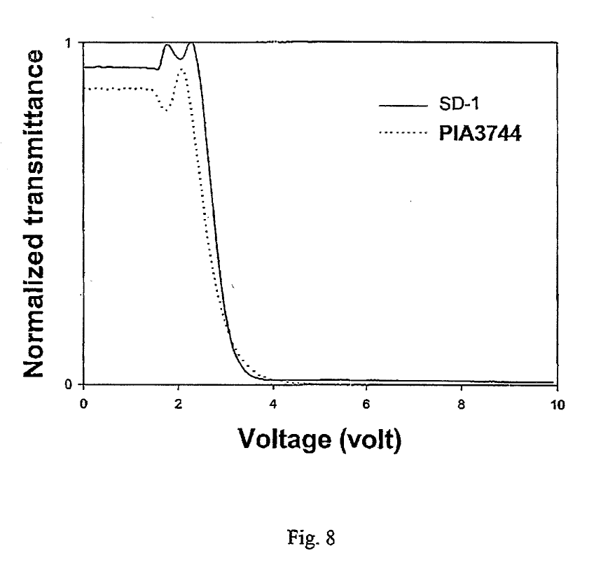

FIG. 8, the transmission voltage curves of a TN-LCD using SD-1 and polyimide PIA3744 as the alignment layer are compared. Polyimide from Chisso Corp and liquid crystal mixture E7 from Merck KGaA are used. The cell gap was 5 μm. The transfer characteristics are similar and very good contrast as the result of homogeneous alignment can be measured directly. It is greater than 70 at the normal incidence. Thus, these results show that the materials of the invention, which are compatible with LCD manufacturing, show promising characteristics for the display applications.

### EXAMPLES

Dyes according to the present invention can be synthesised according to the following general schemes. Although the following schemes exemplify the syntheses of only two dyes (SD-1 and SD-2), it will be clear to the person skilled in the art that the other dyes falling within the scope of the invention can be prepared using analogous starting materials and syntheses.

4,4′-Diaminodiphenyl-3,3′-disulfonic acid (VI) was prepared from 2-nitrobenzenesulphonyl chloride (V) according to Scheme 1:

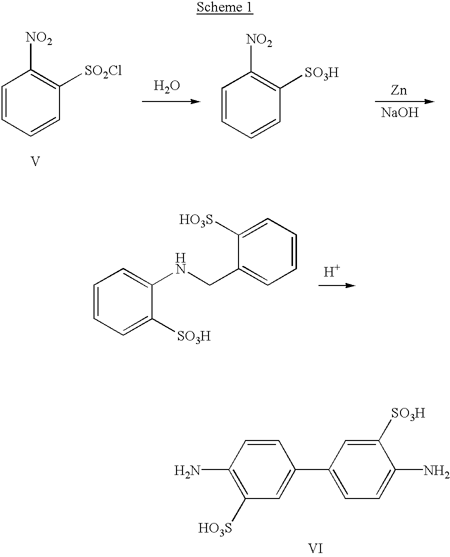

Based on acid (VI), dyes of general formula (VII) were synthesised according to Scheme 2:

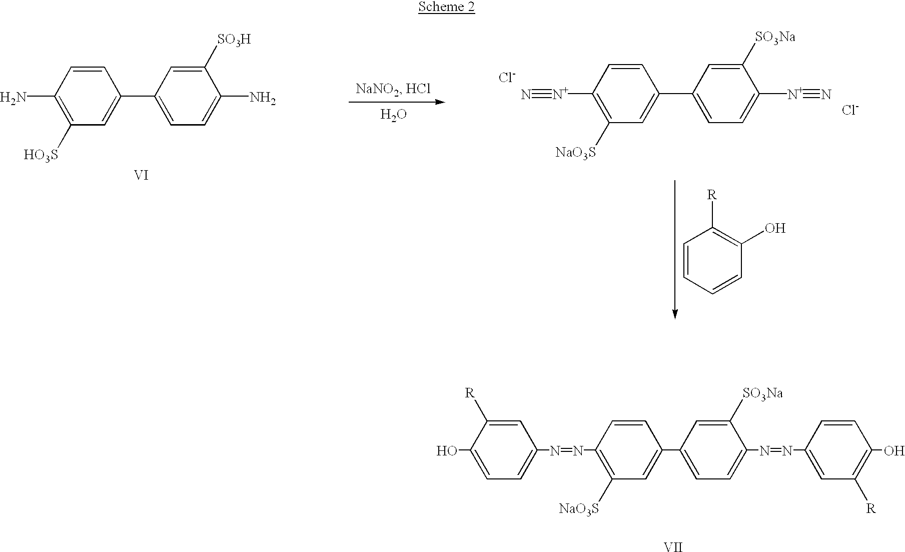

SD-1: R═—COOH

SD-2: R═—CF₃

Benzidine-3,3′-disulfonic acid (VI) was diazotized by adding 0.1 ml of 30% HCl to a solution of 0.55 g (0.0022 mol) of (VI) in aqueous NaNO₂ (0.17 g, 0.0044 mol) at room temperature. On completion of diazotisation (1-2 h), the diazonium mixture was added dropwise to a solution of 0.61 g (0.0044 mol) of 2-hydroxybenzoic acid in 5% Na₂CO₃ (10ml). On completion of coupling (7-10 h) the precipitate was filtered and washed with hot chloroform and acetone to give 0.85 g (60.3%) of the sodium salt of 4,4′-bis (4-hydroxy-3-carboxyphenylazo) benzidine-3,3′-disulphonic acid (SD-1), λₘₐₓ=410 nm.

Dye SD-2 was synthesized according to a similar method, by the diazo-coupling of 0.713 g (0.0044 mol) of 2-trifluoromethyl phenol with diazonium salt of benzidine-3,3′-disulfonic acid (VI) to give 1.5 g (73.3%) of the sodium salt of 4,4′-bis(4-hydroxy-3-trifluoromethylphenylazo) benzidine-3,3′-disulfonic acid (SD-2), λₘₐₓ=498 nm. The products were purified by recrystallization and column chromatography.

### Equivalents

The foregoing is offered primarily for the purposes of illustration. It will be readily apparent to those skilled in the art that numerous variations, modifications and substitutions may be made in the materials, procedural steps and conditions described herein without departing from the spirit and scope of the invention.

Therefore, while this invention has been particularly shown and described with references to certain embodiments thereof, it will be understood by those skilled in the art that various changes in form and details may be made therein without departing from the spirit and scope of the invention encompassed by the appended claims. Such equivalents are intended to be encompassed in the scope of the following claims.

What is claimed is:

1. A compound of the general formula 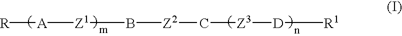
or a salt thereof, wherein
m and n each independently is 1 or 2;
A, B, C and D are each independently selected from the group consisting of an optionally substituted cycloalkylene, an arylene, and a heteroarylene;
Z¹, Z² and Z³ are each independently selected from the group consisting of —N═N—, —CH═CH—, —NH—, —S—, —SO₂, —CH₂—, —CH═N—, —N═CH—, —HN—CO—NH—, —OCH₂—, —CH₂O—, —C≡C—, —O—, —O—CO—, —CO—O—, and a single bond; and Z² additionally is a squarylium or pyridine group; and
R and R¹ are each independently a group 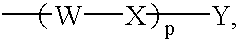
where p is 0,1 or 2, the or each W is selected from the group consisting of —O—, —S—, —SO₂—, —CH₂—, —N═, and a single bond, the or each X is a linear spacer group containing 1 to 8 carbon atoms, and Y is selected from the group consisting of a hydrogen atom, a hydroxyl, carboxyl, nitro, haloalkyl, cyanoalkyl, hydroxyalkyl, alkoxy, haloalkoxy, amino, dialkylamino, and di(hydroxyalkyl) amino.

2. A compound according to claim 1 wherein m and n both represent 1.

3. A compound according to claim 1 wherein at least one of A, B, C and D is cyclohexylene.

4. A compound according to claim 1 wherein at least one of A, B, C and D is phenylene or naphthylene.

5. A compound according to claim 1 wherein A, B, C and D are each optionally substituted by 1 to 4 substituents selected from the group consisting of halogen atoms, hydroxyl, carboxyl, nitro, cyano, amino, —SO₃H, —SO₃Na, C₁₋₆ alkyl, C₁₋₆ haloalkyl, C₁₋₆ alkoxy, C₁₋₆ haloalkoxy, C₁₋₆ alkanoyl, and C₁₋₆ haloalkanoyl groups.

6. A compound according to claim 1 wherein A, B, C and D are each optionally substituted by 1 or 2 substituents selected from the group consisting of halogen atoms, hydroxyl, carboxyl, nitro, cyano, amino, —SO₃H, —SO₃Na, methyl and trifluoromethyl groups.

7. A compound according to claim 1 wherein A, B, C and D are each a 1,4- phenylene group.

8. A compound according to claim 1 wherein A and D are the same and B and C are the same.

9. A compound according to claim 1 wherein A and C are the same and B and D are the same.

10. A compound according to claim 1 wherein Z¹ and Z³ are —N═N— and Z² is a single bond.

11. A compound according to claim 1 wherein p is 0 and Y is selected from the group consisting of a hydrogen atom, a hydroxyl, carboxyl, trifluoromethyl, and C₁₋₈alkoxy group.

12. A compound according to claim 1 wherein m and n are both 1; A and D are both a 1,4-phenylene group optionally substituted at the 3- and 5- positions by a carboxyl group or a trifluoromethyl group; B and C are both a 1,4-phenylene group substituted by a —SO₃Na group; and R and R¹ are both a hydroxy group or a C₁₋₈ alkoxy group.

13. A composition comprising:
a compound of the general formula I as defined in claim 1 or a synthetic dye selected from the group consisting of vat, indigoid, phthalocyanine, aryl carbonium, polymethine, sulphur, nitro squarylium, nitroso squarylium and fluorescent dyes; and an additive to promote adhesion and pretilt angle to a substrate.

14. A composition according to claim 13 wherein the additive is selected from the group consisting of silane derivatives, titanate derivatives and fluorocarbon surfactants.

15. A process for preparing a photo-alignment layer on a substrate comprising the steps of:
(a) selecting and cleaning the substrate;
(b) depositing a film of a composition according to claim 13 onto the substrate;
(c) optionally baking the film to remove any solvent;
(d) illuminating the film in a pre-determined region of the film with actinic radiation directed through at least one aperture mask to form a single-domain structure; and
(e) optionally repeating step (d) with a plurality of aperture masks to form a multi-domain structure.

16. A process according to claim 15 wherein the substrate is selected from the group consisting of glass, silicon, and plastic.

17. A process according to claim 15 wherein the additive in the composition is selected from the group consisting of silane derivatives, titanate derivatives and fluorocarbon surfactants.

18. A liquid crystal device incorporating a photo-alignment layer produced by the process according to claim 15.

19. A liquid crystal device incorporating a photo-alignment layer produced by the process according to claim 16.

20. A liquid crystal device incorporating a photo-alignment layer produced by the process according to claim 17.

21. A process for preparing a photo-alignment layer on a substrate comprising the steps of:
(a) selecting and cleaning the substrate;
(b) depositing a film of a composition according to claim 14 onto the substrate;
(c) optionally baking the film to remove any solvent;
(e) illuminating the film in a pre-determined region of the film with actinic radiation directed through at least one aperture mask to form a single-domain structure; and
(f) optionally repeating step (d) with a plurality of aperture masks to form a multi-domain structure.

22. A process according to claim 21 wherein the substrate is selected from the group consisting of glass, silicon, and plastic.

23. A process according to claim 21 wherein the additive in the composition is selected from the group consisting of silane derivatives, titanate derivatives and fluorocarbon surfactants.

24. A liquid crystal device incorporating a photo-alignment layer produced by the process according to claim 21.

25. A liquid crystal device incorporating a photo-alignment layer produced by the process according to claim 22.

26. A liquid crystal device incorporating a photo-alignment layer produced by the process according to claim 23.
